(19) United States
(12) Patent Application Publication
(10) Pub. No.: US 2008/0136886 A1
(43) Pub. Date: Jun. 12, 2008

(54) Method for printing images on textile fabric

(76) Inventor: Chao-Hsiung Yen, Tsang-Hwa City (TW)

Correspondence Address: PHILLIP LIU, 6980, WHITEOAK DR., RICHMOND, BC, V7EAZ9, omitted

(21) Appl. No.: 11/634,236

(22) Filed: Dec. 6, 2006

(51) Int. Cl. B41J 2/01

(52) U.S. Cl. 347/105

(57) ABSTRACT

A method for pitting images on a cotton fabric includes steps of boil-off and bleaching to the cotton fabric, tiny holes among tangled filaments in the cotton fabric are filled and leveled by a chemical mixture and after the chemical mixture is permeated and consolidated in the tiny holes of the fabric, a photo, landscape picture or drawing is printed by an ink jet process to provide a clear, bright, high-resolution display on the cloth.

### FIELD OF THE INVENTION

The present invention relates to a method for putting images on a textile fabric structure by ink jet directly.

### BACKGROUND OF THE INVENTION

In general, large-area dyed and printed patterns are designed by manufacturers and consumers cannot choose products with large printed patterns such as bed sheets, curtains or sofa covers according to their personal preference.

If a consumer prefers a certain favorite photo, landscape picture or drawing and wants to transfer and print the photos, landscape pictures and drawings onto the bed sheets, curtains or sofa covers, the consumer has to pay lots of money for the typesetting and printing. In addition to the high cost, some portions of the color layers cannot be shown, and such arrangement cannot meet consumer requirements and the cost-effective effect.

A traditional thermal transfer printing to put photos and pictures onto a T-shirt has been proven harmful to a certain level of our body when the T-shirt is in contact with the body for a long period of time. If the thermal transfer printing is applied on objects such as a bed sheet to which the users' body has close contact, the harmful effect definitely exists. Further, if a pattern is produced by the thermal transfer printing, the printed object has a high adhesiveness and will be entangled together with other printed objects during its rinsing and application, and causes a very inconvenient manufacturing process, and the pattern will be peeled or flaked after several times of rinses and washes. In the manufacturing process, it is necessary to produce a desired photo, landscape picture or drawing on a pattern transfer paper (or a thermal pattern transfer paper) first, and then cover the pattern transfer paper (or a thermal pattern transfer paper) onto a desired printing cloth, and finally transfers and prints the pattern onto the cloth by high temperature of heat. Obviously, such process is complicated.

If an existing screen printing technology is used for the color printing and dyeing, it is necessary to produce a screen, and each requires a layer of screen, and such method incurs a high cost for the screen printing for photos, landscape pictures and drawings having several layers of different colors, and thus the method is not suitable for personalized products. Furthermore, the screen printing technique applied for large-area printing and dyeing will cause a color flaking or will distort the whole printing, since the cloth absorbs dyes at different degrees. The screen printing technique cannot achieve print a clear photo, landscape picture or drawing and it sometimes even causes a blurred unidentifiable image.

### SUMMARY OF THE INVENTION

The primary objective of the present invention is to provide a method for easily dyeing or printing images on a textile fabric, the method first takes a cloth to be proceeded by boil-off and bleaching, and then the cloth goes through a leveling process, and the fabric is soaked in a chemical mixture of kaolin, developer, dispersant and color fixative to let the chemical mixture fills into tiny holes between tangled filaments of the cloth. After the chemical mixture is permeated and consolidated in the tiny holes of the cloth, the absorption of dyes into the cloth slows down, and the desired photos, landscape pictures or drawings can be printed onto the cloth by a large computer-controlled ink-jet printer. Since the cloth absorbs the color fixative, no color flaking will be produced during the ink-jet process, and thus the invention can print photos, landscape pictures or drawings onto a cloth with a true and bright effect.

The present invention uses ink-jet printing technology, so that the cloth can absorb dyes evenly, and the dyes can be permeated into the yarns of the cloth to accomplish printing a clear, bright and durable photo, picture or drawing.

Since the present invention uses a large computer ink-jet printer that can save lots of costs and manpower of a traditional screen printing process, therefore the resources can be utilized effectively, and the size of the desired printing objects can be changed freely. Regardless of bed sheets, curtains or sofa covers, all of the desired printing objects can meet customer requirements, and be printed according to a customer's favorite photo, landscape picture or pattern.

### BRIEF DESCRIPTION OF THE DRAWINGS

FIG. 1 shows a personalized photo to be put on a textile fabric;

FIG. 2 shows a preferred embodiment of the present invention;

FIG. 3 shows another preferred embodiment of the present invention;

FIG. 4 shows a flow chart of the present invention; and

FIG. 5 shows a process of dyeing and printing process in accordance with a preferred embodiment of the present invention.

### DETAILED DESCRIPTION OF THE EMBODIMENTS

The objectives, shape, structure, apparatus, characteristics and effects of the present invention will become apparent by the detail description together with the accompanying drawings. Some of the elements of the present invention may be substituted by their equivalents, and the detailed description of preferred embodiments given in the specification illustrates the structure of the invention.

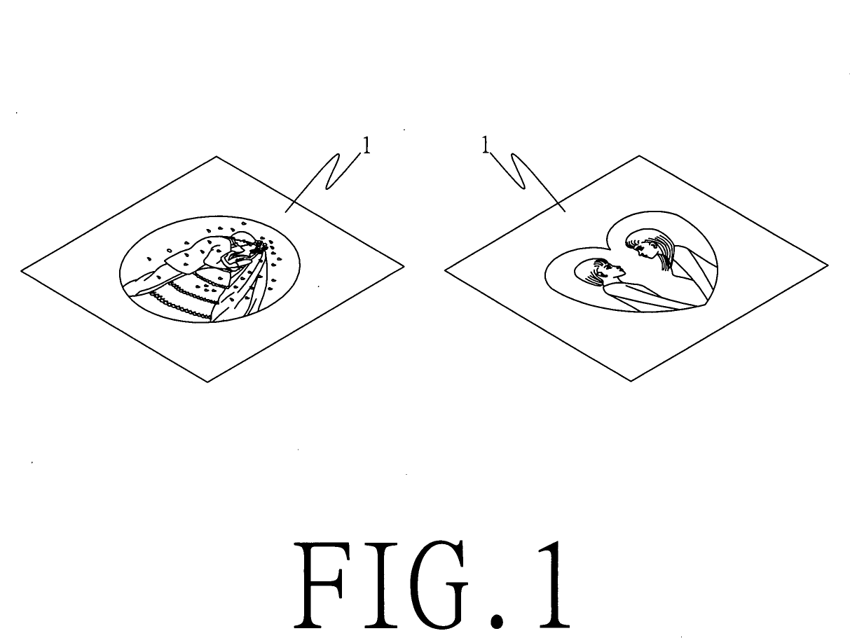

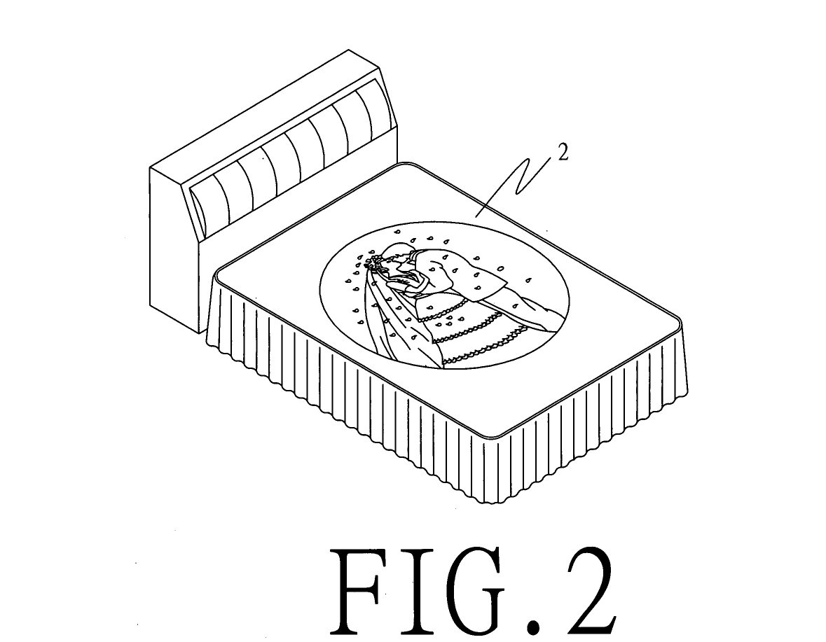

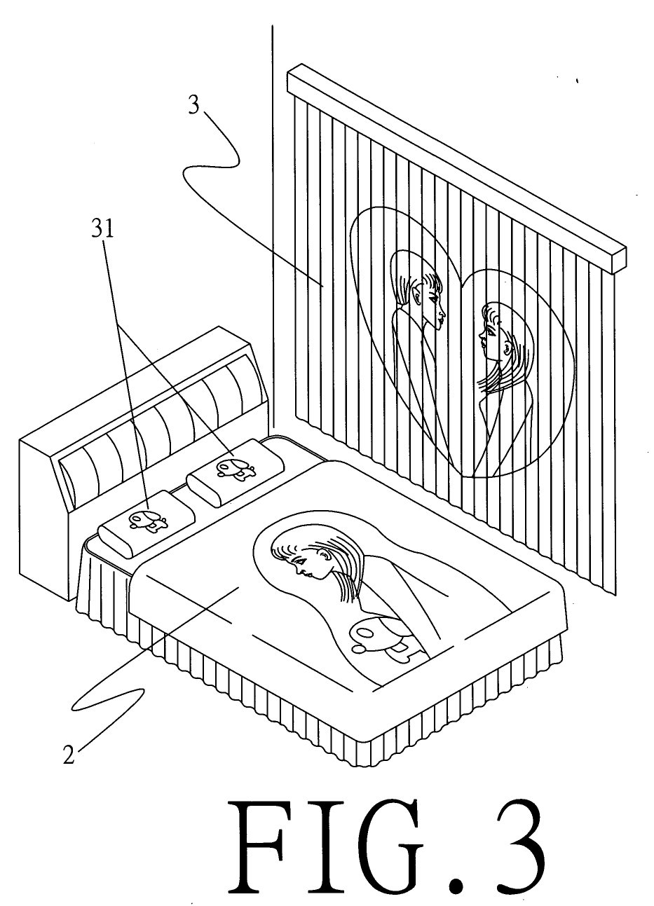

FIG. 1 shows a personalized photo to be put on the textile fabric and FIGS. 2 and 3 are preferred embodiments and flow chart of the textile fabric used in the method.

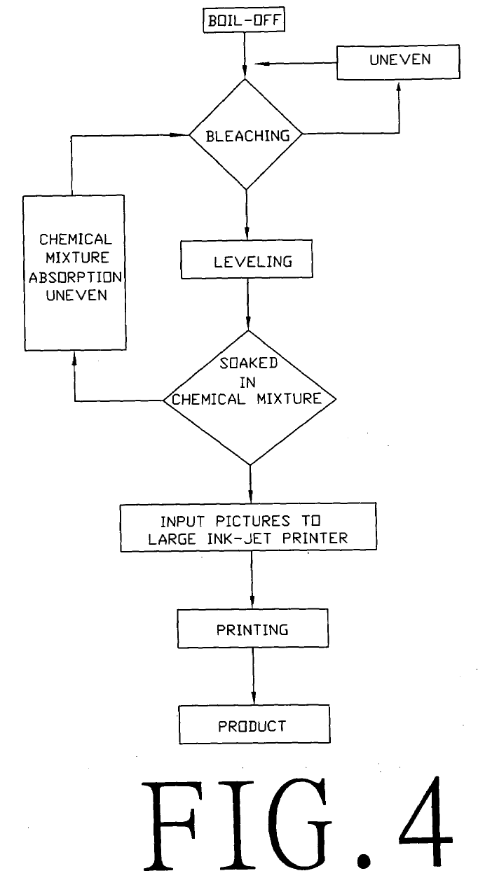

Referring to FIG. 4, the method of the present invention 1 of the present invention is to proceed a boil-off and bleaching process to soften a cloth, and the cloth goes through a leveling process, and then the cloth is soaked in a mixture of kaolin, developer, dispersant and color fixative to let the chemical mixture fills the tiny holes between tangled filaments. After the chemical mixture is permeated and consolidated in the tiny holes of the cloth, the absorption of the chemical mixture by the cloth is slowed down to a certain level, and the desired photos, landscape pictures or drawings can be printed by an ink jet process directly onto the cloth by a large computer-controlled ink-jet printer. Since the color fixative is absorbed by the cloth and a large computer ink-jet printer and ink are used for the printing, the level of absorbing dyes by the cloth can be adjusted by a direct proportional method to avoid color flaking during the ink jet process and improve the line, brightness and resolution to show a 100% true development effect.

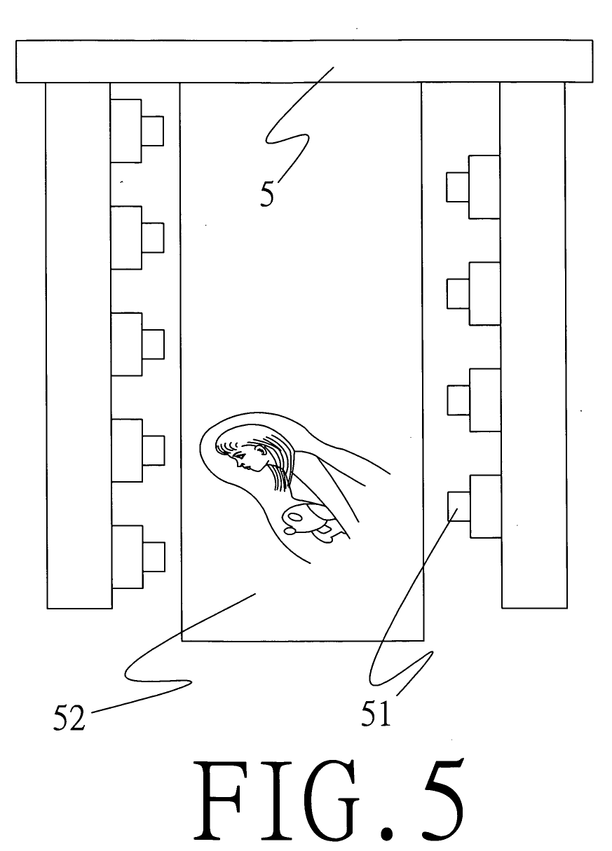

Referring to FIG. 5, the large computer-controlled ink-jet printer installs a plurality of multi-nozzle modules 51, and the multi-nozzle module includes “A” nozzles separated with each other by a regular distance “B” mm (for users to set the level of resolution) for printing and dyeing “C” mm color photos, landscape pictures or patterns (users can set the size of printing and dyeing area) on a continuously traveling tubular object 52 (or cloth), wherein the total number of multi-nozzles is equal to “D”, which is calculated by dividing the width by the product of the number of nozzles and the distance (D=C/A×B) and arranged in pairs, and the direction of each nozzle of the multi-nozzle module is perpendicular to the traveling direction of the tubular object 52 (or cloth), and all nozzles are fixed continuously along the traveling path of the tubular object 52 (or cloth) and arranged alternatively, so that the tubular object 52 (or cloth) will not be stacked transversally with each other on the traveling path, and the photos, landscape pictures or patterns can be shown on the tubular object 52 (or cloth) in a clear, bright and high-resolution manner. It is noted that the present invention can also be used for small-area produces such as seat pad, seat clothes and bags.

While the invention has been described by means of a specific numerous modifications and variations could be made thereto by those skilled in the art without departing from the scope and spirit of he invention set forth in the claims.

What is claimed is:

1. A method for pitting images on a textile fabric, wherein the method takes steps of boil-off and bleaching to the cotton fabric, the textile fabric is soaked in a chemical mixture and tiny holes among tangled filaments in the cotton fabric are filled by the chemical mixture, after the chemical mixture is permeated and consolidated in the tiny holes of the cloth, a photo, landscape picture or drawing is printed on the cloth by an ink jet process.

2. The method as claimed in claim 1, wherein the chemical mixture is a mixture of kaolin, developer, dispersant and color fixative.

3. The method as claimed in claim 1, wherein the cloth is a curtain, a bed sheet, a bed fitted, a sofa cover, a pillow case or a couch pillow.

4. The method as claimed in claim 1, wherein the large computer-controlled ink-jet printer is comprised of a multi-nozzle module.

5. The method as claimed in claim 1, wherein the multi-nozzle modules are separated at a predetermined distance from each other and disposed perpendicular to the textile fabric.
